(19) United States
(12) Patent Application Publication
(10) Pub. No.: US 2026/0264350 A1
(43) Pub. Date: Sep. 10, 2026

(54) INSERT-MOLDED ARTICLE PRODUCTION METHOD, INSERT-MOLDING DIE, AND INSERT-MOLDED ARTICLE

(71) Applicant: Yazaki Corporation, Tokyo (JP)

(72) Inventors: Shoya SUGIYAMA, Shizuoka (JP); Kazuhiro TSUCHIDA, Shizuoka (JP); Tomohiro SHIBATA, Shizuoka (CN)

(73) Assignee: Yazaki Corporation, Tokyo (JP)

(21) Appl. No.: 19/530,552

(22) Filed: Feb. 5, 2026

(30) Foreign Application Priority Data
Mar. 10, 2025 (JP) 2025-037135

(51) Int. Cl. B29C 70/68; B29C 70/78; B29K 705/00; B29L 31/30

(52) U.S. Cl. CPC B29C 70/682; B29C 70/78; B29K 2705/00; B29L 2031/30

(57) ABSTRACT

An insert-molded article production method includes: an insert step of arranging a metal collar in a first die; a clamping step of clamping a second die, which includes a rotatably-held protrusion forming pin formed in a clamping direction D1 and having a pressing protrusion protruding in a direction intersecting with the clamping direction, and the first die, rotating and inserting the protrusion forming pin into a cylindrical portion in a state in which movement of the metal collar around an axis is restricted, and forming a locking protrusion on an outer periphery of the cylindrical portion; and a molding step of filling a cavity formed around the cylindrical portion by the first die and the second die with resin.

### CROSS-REFERENCE TO RELATED APPLICATIONS

The present application claims priority to and incorporates by reference the entire contents of Japanese Patent Application No. 2025-037135 filed in Japan on March 10, 2025.

### BACKGROUND OF THE INVENTION

### 1. Field of the Invention

The present invention relates to an insert-molded article production method, an insert-molding die, and an insert-molded article.

### 2. Description of the Related Art

As a technique related to a conventional insert-molded article production method, insert-molding die, and insert-molded article, for example, JP 2004 – 042 561 A discloses an insert-molded article production method, an insert-molding die, and an insert-molded article, in which after a collar made of a metal material having easily deformable portions respectively formed at both end portions is set in a molding die, an upper die and a lower die are brought close to each other to crush the easily deformable portions, and molding is performed in a state in which a flat surface formed by crushing of the easily deformable portions is in close contact with the upper die or the lower die.

Such an insert-molded article production method, an insert-molding die, and an insert-molded article may be configured in such a manner as not to easily come off from a resin molded portion by, for example, performance of knurling or the like on an outer periphery of a metal collar. There is still room for further improvement in a configuration in which the metal collar is assembled to a resin molded portion.

### SUMMARY OF THE INVENTION

The present invention has been made in view of the above circumstances, and an object thereof is to provide an insert-molded article production method, an insert-molding die, and an insert-molded article capable of appropriately assembling a metal collar to a resin molded portion.

In order to achieve the above mentioned object, an insert-molded article production method according to one aspect of the present invention includes an insert step of performing an arrangement in a first die in such a manner that an axis of a tubular portion of a metal collar including the tubular portion is in a clamping direction; a clamping step of clamping a second die, which includes a rotatably-held protrusion forming pin formed in the clamping direction and having a pressing protrusion protruding in a direction intersecting with the clamping direction, and the first die, rotating and inserting the protrusion forming pin into the tubular portion in a state in which movement of the metal collar around the axis is restricted, and forming a locking protrusion on an outer periphery of the tubular portion; and a molding step of filling a cavity formed around the tubular portion by the first die and the second die with resin.

In order to achieve the above mentioned object, an insert-molding die according to another aspect of the present invention includes a first die that is formed in such a manner that a metal collar including a tubular portion can be arranged with an axis of the tubular portion of the metal collar being in a clamping direction, and has a first cavity forming surface provided in a manner corresponding to an outer periphery of the tubular portion; a second die including a rotatably-held protrusion forming pin that is formed to be insertable into the tubular portion in the clamping direction and has a pressing protrusion protruding in a direction intersecting with the clamping direction, and a second cavity forming surface provided in a manner corresponding to an outer periphery of the tubular portion; and a cavity that includes the first cavity forming surface and the second cavity forming surface, and is formed in the outer periphery of the tubular portion by clamping of the first die and the second die.

In order to achieve the above mentioned object, an insert-molded article according to still another aspect of the present invention includes a metal collar including a tubular portion; and a resin molded portion to which the metal collar is assembled, wherein the tubular portion has a locking protrusion that protrudes in a spiral shape outward in a radial direction in a manner corresponding to a spiral recess portion formed in an inner peripheral surface, and that bites the resin molded portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view illustrating a schematic configuration of an insert-molded article according to an embodiment;

FIG. 2 is a sectional view illustrating a schematic configuration of an insert-molding die according to the embodiment;

FIG. 3 is a flowchart illustrating an insert-molded article production method according to the embodiment;

FIG. 4 is a sectional view illustrating a state in which the insert-molding die according to the embodiment is clamped;

FIG. 5 is a sectional view illustrating a state in which a protrusion forming pin according to the embodiment is inserted into a metal collar and a locking protrusion is formed; and

FIG. 6 is a side view illustrating a protrusion forming pin according to a modification example of the embodiment.

### DETAILED DESCRIPTION OF THE PREFERRED EMBODIMENTS

In the following, an embodiment according to the present invention will be described in detail on the basis of the drawings. Note that this invention is not limited to this embodiment. In addition, components in the following embodiment include those that can be easily replaced by those skilled in the art or those that are substantially the same.

### Embodiment

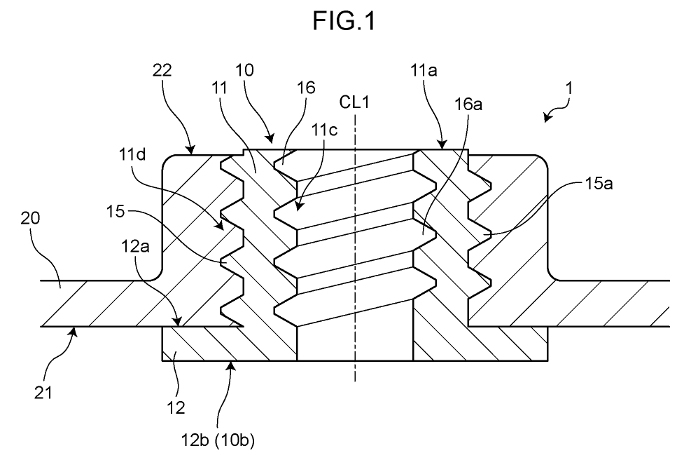

An insert-molded article 1 of the present embodiment illustrated in FIG. 1 can be, for example, a protector incorporated in a wire harness routed in a vehicle such as an automobile. Here, for example, the wire harness is configured in such a manner that a plurality of wiring materials used for power supply and signal communication is bundled to form a collective component for connection between devices mounted on the vehicle and the plurality of wiring materials is connected to each of the devices by a connector or the like. Each of the wiring materials is, for example, an insulated wire in which a core wire acquired by bundling of a plurality of conductive metal wires is covered with an insulating covering portion. The wiring material may be a bundle of a plurality of the insulated wires. The protector as the insert-molded article 1 protects the wiring materials routed inside, and is fixed to the vehicle to restrict a routed path of the wiring materials.

The protector as the insert-molded article 1 includes a metal collar 10, and a resin molded portion 20 serving as a protector main body to which the metal collar 10 is assembled. The metal collar 10 is made of, for example, a conductive metal material, and is formed in a substantially cylindrical shape around an axis CL1. The metal collar 10 includes a cylindrical portion 11 (tubular portion) formed in a substantially cylindrical shape, and a flange portion 12 formed at an end portion of the cylindrical portion 11 on one side in a direction of the axis CL1.

Note that in the following description, the one side (side of the flange portion 12) in the direction of the axis CL1 of the metal collar 10 will be referred to as a lower side, and the other side will be referred to as an upper side.

Although not illustrated, for example, a round terminal of a ground terminal is made to come into contact with an upper end surface 11a of the cylindrical portion 11 of the metal collar 10, a lower surface 12b of the flange portion 12 (lower surface 10b that is a lower end surface of the metal collar 10) is made to come into contact with a body of the vehicle or the like, and a bolt is inserted into the cylindrical portion 11, whereby the insert-molded article 1 is fixed to the body of the vehicle or the like together with the ground terminal. As a result, the ground terminal is electrically connected to the body of the vehicle or the like via the metal collar 10. The end surface 11a of the cylindrical portion 11 and the lower surface 10b of the metal collar 10 are formed in a flat surface shape. Note that an upper surface 22 of the resin molded portion 20 around the cylindrical portion 11 is positioned below (on the other side of) the upper end surface 11a of the cylindrical portion 11. Thus, the ground terminal securely abuts on the end surface 11a of the metal collar 10. Furthermore, the resin molded portion 20 is provided above an upper surface 12a of the flange portion 12. Thus, the flange portion 12 is exposed from a lower surface 21 of the resin molded portion 20.

An outer peripheral surface 11d of the cylindrical portion 11 of the metal collar 10 is provided with a locking protrusion 15 protruding in a continuous spiral shape. Note that the locking protrusion 15 may be formed in the continuous spiral shape, or the locking protrusion 15 may be formed for a predetermined length or may be formed intermittently. Similarly, an inner peripheral surface 11c of the cylindrical portion 11 is also provided with a continuous spiral recess portion 16. Spiral recess and protrusion are formed in the outer peripheral surface 11d and the inner peripheral surface 11c of the cylindrical portion 11 by the locking protrusion 15 and the recess portion 16. The locking protrusion 15 is provided in a manner corresponding to the recess portion 16. For example, a second recess-shaped portion 16a from the bottom of the recess portion 16 in a cross section of FIG. 1 corresponds to a second protrusion-shaped portion 15a from the bottom of the locking protrusion 15. The locking protrusion 15 bites the resin molded portion 20 and locks the metal collar 10 to the resin molded portion 20.

In the insert-molded article 1, the resin molded portion 20 is arranged on an outer periphery of the cylindrical portion 11 around the axis CL1 by insert-molding in which the metal collar 10 is inserted, and the metal collar 10 and the resin molded portion 20 are integrally formed. The upper surface 12a of the flange portion 12 of the metal collar 10 abuts on the lower surface 21 of the resin molded portion 20. Thus, the metal collar 10 is prevented from coming off in an upper direction.

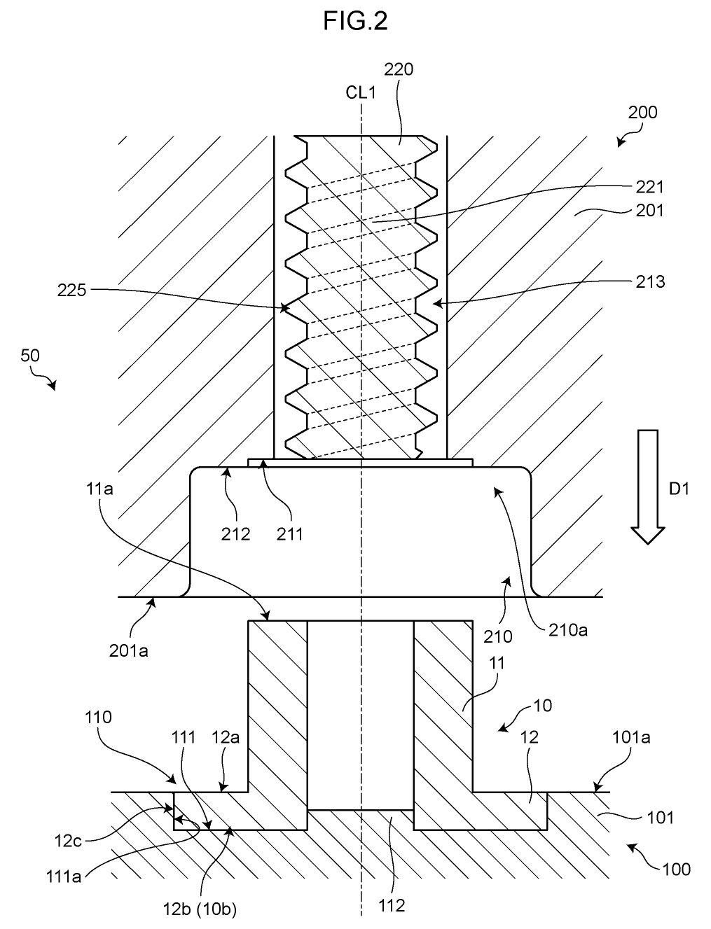

As illustrated in FIG. 2, an insert-molding die 50 to produce the insert-molded article 1 includes a first die 100 and a second die 200. In the insert-molding die 50, for example, the first die 100 can be arranged on a lower fixation side in a vertical injection molding device, and the second die 200 can be arranged on an upper movable side. The first die 100 and the second die 200 are brought relatively close to each other and clamped, and are relatively separated from each other and opened. Specifically, as indicated in a clamping direction D1, the second die 200 is moved from the upper side to the lower side and clamped, and is moved to a side opposite to the clamping direction D1, that is, from the lower side to the upper side and opened.

The first die 100 is formed in such a manner that the metal collar 10 can be arranged in such a manner that the axis CL1 of the cylindrical portion 11 of the metal collar 10 including the cylindrical portion 11 is in the clamping direction D1. That is, the first die 100 includes a first die main body 101 and a metal collar support portion 110 provided on the first die main body 101. An upper surface of the first die main body 101 is formed in a flat surface shape and serves as a first cavity forming surface 101a that forms a cavity 250 (described later). The first cavity forming surface 101ais provided in a manner corresponding to the outer periphery of the cylindrical portion 11 (that is, the resin molded portion 20 is formed on the outer periphery of the cylindrical portion 11). The metal collar support portion 110 supports the metal collar 10 including the cylindrical portion 11. The metal collar support portion 110 is provided on the first cavity forming surface 101a of the first die main body 101.

Specifically, the metal collar support portion 110 has a placement surface 111 on which the lower surface 10b of the metal collar 10 (that is, the lower end surface of the metal collar 10) is placed in an abutted manner. The placement surface 111 is a bottom surface of a recessed groove recessed annularly from the first cavity forming surface 101a. A collar support column 112 formed in a columnar shape, which is a thin round columnar shape, is formed inside the annular shape of the placement surface 111. The collar support column 112 is inserted into the cylindrical portion 11 from the lower side of the metal collar 10. An annular peripheral surface 111a erected on an outer edge of the placement surface 111 abuts on an outer peripheral surface 12c of the flange portion 12 of the metal collar 10. Movement of the metal collar 10 in a direction parallel to the first cavity forming surface 101a is restricted by the metal collar support portion 110 including the placement surface 111 and the collar support column 112. As a result, a protrusion forming pin 220 can be securely inserted into the cylindrical portion 11. A distance from the first cavity forming surface 101a to the placement surface 111 (that is, a depth of the placement surface 111) is equal to a thickness of the flange portion 12 of the metal collar 10. In other words, the first cavity forming surface 101a provided adjacent to the placement surface 111 is formed shallower than the placement surface 111.

The second die 200 includes a second die main body 201. A lower surface 201a of the second die main body 201 is formed in a flat surface shape. The lower surface 201a of the second die main body 201 is a cavity forming surface of the second die main body 201 that forms the cavity 250. The lower surface 201a of the second die main body 201 is provided with a recess portion 210 formed in a substantially circular recessed shape in plan view.

A bottom portion 210a of the recess portion 210 is provided with a collar end surface abutment surface 211, a second cavity forming surface 212, and a pin housing portion 213. The collar end surface abutment surface 211 has a thin annular recessed shape in plan view and is formed in a substantially flat surface shape. The collar end surface abutment surface 211 abuts on the upper end surface 11a of the metal collar 10 when the first die 100 and the second die 200 are clamped. On the other hand, the second cavity forming surface 212 is provided outside in a radial direction of the collar end surface abutment surface 211. The second cavity forming surface 212 is provided in a manner corresponding to the outer periphery of the cylindrical portion 11. Specifically, the second cavity forming surface 212 is provided in an annular flat surface shape in plan view in a manner adjacent to the outer side in the radial direction of the collar end surface abutment surface 211, and is formed shallower than the collar end surface abutment surface 211. The second cavity forming surface 212 is a cavity forming surface of the cavity 250 that forms the upper surface 22 of the resin molded portion 20 on the upper outer periphery of the cylindrical portion 11. The pin housing portion 213 is formed as a circular hole elongated in the clamping direction D1. The pin housing portion 213 is provided with the protrusion forming pin 220.

The protrusion forming pin 220 is formed to be insertable into the cylindrical portion 11 in the clamping direction D1. The protrusion forming pin 220 has a pressing protrusion 225 protruding in a direction orthogonal to and intersecting with the clamping direction D1 and is rotatably held by the second die 200. Specifically, the protrusion forming pin 220 has a substantially round columnar shaft portion 221 that is long in the clamping direction D1, and the pressing protrusion 225 is formed in a spiral shape continuous in such a manner as to be wound around an outer periphery of the shaft portion 221. In other words, the protrusion forming pin 220 is formed in a screw shaft shape.

The placement surface 111 and the collar support column 112 of the metal collar support portion 110 in the first die 100, and the collar end surface abutment surface 211 and the second cavity forming surface 212 of the recess portion 210, and the protrusion forming pin 220 in the second die 200 are arranged concentrically. In other words, the axis CL1 of the metal collar 10 arranged on the metal collar support portion 110 coincides with each of the axes of the placement surface 111 and the collar support column 112 of the metal collar support portion 110 in the first die 100, and the collar end surface abutment surface 211 and the second cavity forming surface 212 of the recess portion 210 in the second die 200, which are arranged concentrically.

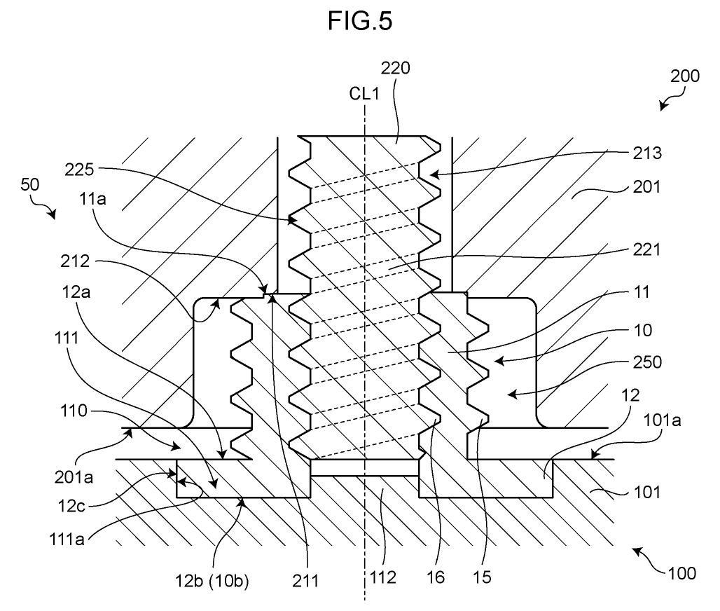

Each of the first die 100 and the second die 200 has a parting surface (not illustrated). The first die 100 and the second die 200 are clamped by being brought relatively close to each other and the parting surfaces thereof being made to abut on each other. By clamping of the first die 100 and the second die 200, the cavity 250 that is closed space including the first cavity forming surface 101a of the first die 100, and the lower surface 201a and the second cavity forming surface 212 of the second die 200 is formed. The cavity 250 is formed around the cylindrical portion 11 of the metal collar 10 arranged on the metal collar support portion 110 of the first die 100 (outer periphery of the cylindrical portion 11 around the axis CL1) (see FIG. 5).

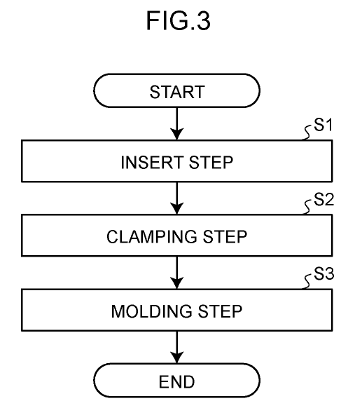

As illustrated in FIG. 3, an insert-molded article production method to produce the insert-molded article 1 by using the insert-molding die 50 includes an insert step (Step S1), a clamping step (Step S2), and a molding step (Step S3).

The insert step (Step S1); as illustrated in FIG. 2, in the insert step (Step S1), the insert-molding die 50 is opened, and the metal collar 10 before being processed with the insert-molding die 50 is arranged in the first die 100 in such a manner that the axis CL1 of the cylindrical portion 11 is in the clamping direction D1. Specifically, the metal collar 10 is arranged on the metal collar support portion 110 of the first die 100 with the flange portion 12 facing the first die 100. At this time, the metal collar 10 is arranged in such a manner that the lower surface 10b that is the lower end surface of the metal collar 10 abuts on the placement surface 111. In addition, when the metal collar 10 is arranged on the metal collar support portion 110, the collar support column 112 is inserted into the cylindrical portion 11 of the metal collar 10. The outer peripheral surface 12c of the flange portion 12 abuts on an annular side wall 111c of the metal collar support portion 110 on an outer periphery of the placement surface 111.

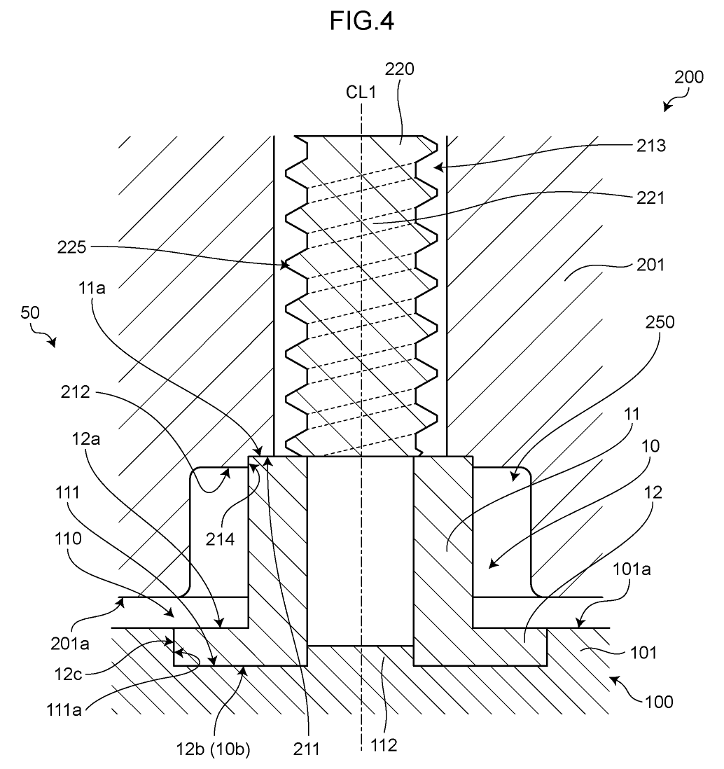

The clamping step (Step S2); the second die 200 is moved in the clamping direction D1, and the first die 100 and the second die 200 are clamped as illustrated in FIG. 4 in the clamping step (Step S2) after the insert step (Step S1). When the first die 100 and the second die 200 are clamped, the collar end surface abutment surface 211 of the second die 200 abuts on the upper end surface 11a of the cylindrical portion 11. An inner peripheral surface of an annular connection step portion 214 connecting the collar end surface abutment surface 211 and the second cavity forming surface 212 abuts on an outer peripheral surface of the cylindrical portion 11 on a side of the end surface 11a. When the first die 100 and the second die 200 are clamped, the metal collar 10 is sandwiched between the collar end surface abutment surface 211 and the placement surface 111, and the movement of the metal collar 10 around the axis CL1 is restricted.

Then, as illustrated in FIG. 5, the protrusion forming pin is rotated and inserted into the cylindrical portion 11. Then, by the pressing protrusion 225, the recess portion 16 is formed in the inner peripheral surface 11c of the cylindrical portion 11, and the locking protrusion 15 is formed on the outer peripheral surface 11d. Both the recess portion 16 and the locking protrusion 15 are formed in a continuous spiral shape.

The molding step (Step S3); the cavity 250 formed by clamping of the insert-molding die 50 in the clamping step (Step S2) is filled with resin in the molding step (Step S3). When the cavity 250 is filled with resin, the resin molded portion 20 is formed on the outer periphery of the cylindrical portion 11. The resin to be filled is filled in such a manner that the locking protrusion 15 bites the resin molded portion 20 around the cylindrical portion 11.

After completion of the molding step (Step S3), the second die 200 is raised to open the first die 100 and the second die 200, and the molded insert-molded article 1 is taken out from the first die 100. In such a manner, the insert-molded article 1 can be acquired by the insert-molded article production method using the insert-molding die 50.

### Modification example

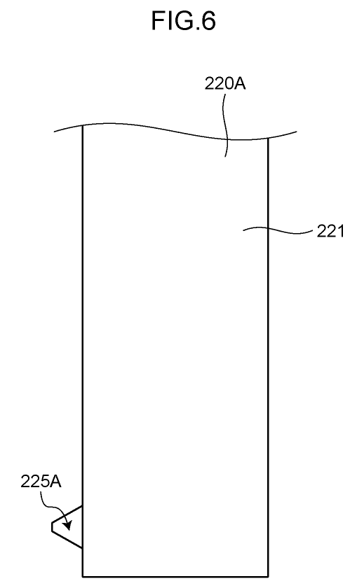

A protrusion forming pin 220A according to the modification example of the present embodiment is illustrated in FIG. 6. In the protrusion forming pin 220A according to the present modification example, one pressing protrusion 225A formed in a boss shape protruding outward in a radial direction from a shaft portion 221 is included instead of the spiral pressing protrusion 225. In the clamping step (Step S2), the protrusion forming pin 220A is rotated and inserted, whereby the pressing protrusion 225A presses the inner peripheral surface 11c of the cylindrical portion 11, and the spiral locking protrusion 15 can be formed on the outer periphery (outer peripheral surface 11d) of the cylindrical portion 11. Note that although the pressing protrusion 225A is formed in a substantially truncated cone shape, various forms such as a pyramid shape can be adopted.

The insert-molded article production method described above includes the insert step of performing an arrangement in the first die 100 in such a manner that the axis CL1 of the cylindrical portion 11 of the metal collar 10 including the cylindrical portion 11 is in the clamping direction D1 (Step S1), the clamping step of clamping the second die 200, which includes the rotatably-held protrusion forming pin 220 formed in the clamping direction D1 and having the pressing protrusion 225 protruding in the direction intersecting with the clamping direction D1, and the first die 100, rotating and inserting the protrusion forming pin 220 into the cylindrical portion 11 in a state in which movement of the metal collar 10 around the axis CL1 is restricted, and forming the locking protrusion 15 on the outer periphery of the cylindrical portion 11 (Step S2), and the molding step of filling the cavity 250 formed around the cylindrical portion 11 by the first die 100 and the second die 200 with resin (Step S3).

Thus, in the insert-molded article 1, the locking protrusion 15 is formed on the cylindrical portion 11 of the metal collar 10 and made to bite the resin molded portion 20, whereby the metal collar 10 can be assembled to the resin molded portion 20. Thus, the metal collar 10 is securely prevented from coming off in an upper and lower directions by the portion where the locking protrusion 15 bites the resin molded portion 20. For example, as a protector provided in the wire harness that mounts the insert-molded article 1 on the vehicle, the metal collar 10 is fastened to the body of the vehicle together with the ground terminal by the bolt. Also in this case, in the insert-molded article 1, the metal collar 10 is prevented from easily falling off from the resin molded portion 20 due to vibration or the like at the time of bolt fastening or traveling of the vehicle. Thus, according to the insert-molded article production method of the present embodiment, the metal collar 10 can be appropriately assembled to the resin molded portion 20.

That is, according to the present embodiment, it is possible to acquire the insert-molded article 1 in which the metal collar 10 is prevented from coming off from the resin molded portion 20 even when insert molding in which assembling to the resin molded portion 20 is performed by utilization of, for example, a metal collar of a known form including the cylindrical portion 11 and the flange portion 12 is performed. Thus, it is not necessary to separately perform processing such as knurling on the metal collar.

Furthermore, the pressing protrusion 225 is formed in a spiral shape, and the spiral locking protrusion 15 is formed on the outer periphery of the cylindrical portion 11 by the pressing protrusion 225 in the clamping step (Step S2). As a result, the spiral locking protrusion 15 formed continuously bites the resin molded portion 20, whereby the metal collar 10 is more securely prevented from coming off.

Furthermore, the pressing protrusion 225A is formed in a boss shape, and the spiral locking protrusion 15 is formed on the outer periphery of the cylindrical portion 11 by the pressing protrusion 225 in the clamping step (Step S2). As a result, the protrusion forming pin 220A includes the boss-shaped pressing protrusion 225A, and the structure can be easily formed.

In addition, the second die 200 has the collar end surface abutment surface 211 that abuts on the end surface 11a of the cylindrical portion 11, and the collar end surface abutment surface 211 is made to abut on the end surface 11a of the cylindrical portion 11 and pressed to restrict the movement of the metal collar 10 around the axis CL1 in the clamping step (Step S2). This makes it possible to easily restrict the movement of the metal collar 10 around the axis CL1 without providing a special device.

Furthermore, the insert-molding die 50 includes the first die 100 that is formed in such a manner that the metal collar 10 can be arranged with the axis CL1 of the cylindrical portion 11 of the metal collar 10 including the cylindrical portion 11 being in the clamping direction D1 and has the first cavity forming surface 101a provided in a manner corresponding to the outer periphery of the cylindrical portion 11, the second die 200 having the rotatably-held protrusion forming pin 220, which is formed in a manner of being insertable into the cylindrical portion 11 in the clamping direction D1 and has the pressing protrusion 225 protruding in the direction intersecting with the clamping direction D1, and the second cavity forming surface 212 provided in a manner corresponding to the outer periphery of the cylindrical portion 11, and the cavity 250 that includes the first cavity forming surface 101a and the second cavity forming surface 212, and that is formed in the outer periphery of the cylindrical portion 11 by clamping of the first die 100 and the second die 200. According to the insert-molding die 50, it is possible to produce the insert-molded article 1 in which the spiral locking protrusion 15 is formed on the outer periphery of the cylindrical portion 11 of the metal collar 10 and is made to bite the resin molded portion 20, and the metal collar 10 is appropriately assembled to the resin molded portion 20 in such a manner as to securely function as the ground terminal.

In addition, the insert-molded article 1 includes the metal collar 10 including the cylindrical portion 11, and the resin molded portion 20 to which the metal collar 10 is assembled, and the cylindrical portion 11 has the locking protrusion 15 that protrudes in the spiral shape outward in the radial direction in a manner corresponding to the spiral recess portion 16 formed in the inner peripheral surface 11c and bites the resin molded portion 20. Thus, the metal collar 10 of the insert-molded article 1 is appropriately assembled to the resin molded portion 20 in such a manner as to be less likely to fall off from the resin molded portion 20.

Note that the insert-molded article production method, the insert-molding die, and the insert-molded article according to the embodiment of the present invention described above are not limited to the embodiment described above, and various modifications can be made within the scope described in the claims.

In the above description, the movement of the metal collar 10 around the axis CL1 is restricted by being sandwiched between the collar end surface abutment surface 211 and the placement surface 111 in the clamping step (Step S2). However, as long as the movement of the metal collar 10 around the axis CL1 can be restricted, other configurations can be adopted by pressing of the flange portion 12 from a circumferential direction or by utilization of a separate rotation restriction device. Although the flange portion 12 is provided in the metal collar 10, a metal collar not provided with the flange portion 12 (that is, only including the cylindrical portion 11) can also be used. In addition, although the metal collar 10 is formed in a substantially cylindrical shape and includes the cylindrical portion 11 in the present embodiment, what is formed in a substantially tubular shape such as a substantially quadrangular tubular shape can also be adopted, for example.

The insert-molded article production method, the insert-molding die, and the insert-molded article according to the present embodiment may be configured by appropriate combination of the components of the embodiment and the modification example described above.

The insert-molded article production method, the insert-molding die, and the insert-molded article according to the present embodiment have an effect that the metal collar can be appropriately assembled to the resin molded portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An insert-molded article production method comprising:
an insert step of performing an arrangement in a first die in such a manner that an axis of a tubular portion of a metal collar including the tubular portion is in a clamping direction;
a clamping step of clamping a second die, which includes a rotatably-held protrusion forming pin formed in the clamping direction and having a pressing protrusion protruding in a direction intersecting with the clamping direction, and the first die, rotating and inserting the protrusion forming pin into the tubular portion in a state in which movement of the metal collar around the axis is restricted, and forming a locking protrusion on an outer periphery of the tubular portion; and
a molding step of filling a cavity formed around the tubular portion by the first die and the second die with resin.

2. The insert-molded article production method according to claim 1, wherein
the pressing protrusion is formed in a spiral shape, and
the locking protrusion having a spiral shape is formed on the outer periphery of the tubular portion by the pressing protrusion in the clamping step.

3. The insert-molded article production method according to claim 1, wherein
the pressing protrusion is formed in a boss shape, and
the locking protrusion having a spiral shape is formed on the outer periphery of the tubular portion by the pressing protrusion in the clamping step.

4. The insert-molded article production method according to claim 1, wherein
the second die has a collar end surface abutment surface that abuts on an end surface of the tubular portion, and
the collar end surface abutment surface is made to abut on the end surface of the tubular portion and is pressed to restrict movement of the metal collar around the axis in the clamping step.

5. An insert-molding die comprising:
a first die that is formed in such a manner that a metal collar including a tubular portion can be arranged with an axis of the tubular portion of the metal collar being in a clamping direction, and has a first cavity forming surface provided in a manner corresponding to an outer periphery of the tubular portion;
a second die including a rotatably-held protrusion forming pin that is formed to be insertable into the tubular portion in the clamping direction and has a pressing protrusion protruding in a direction intersecting with the clamping direction, and a second cavity forming surface provided in a manner corresponding to an outer periphery of the tubular portion; and
a cavity that includes the first cavity forming surface and the second cavity forming surface, and is formed in the outer periphery of the tubular portion by clamping of the first die and the second die.

6. An insert-molded article comprising:
a metal collar including a tubular portion; and
a resin molded portion to which the metal collar is assembled, wherein
the tubular portion has a locking protrusion that protrudes in a spiral shape outward in a radial direction in a manner corresponding to a spiral recess portion formed in an inner peripheral surface, and that bites the resin molded portion.
